(19) United States
(12) Patent Application Publication
(10) Pub. No.: US 2024/0411864 A2
(43) Pub. Date: Dec. 12, 2024

(54) SYSTEM AND METHOD FOR DETECTION OF ANOMALOUS CONTROLLER AREA NETWORK (CAN) MESSAGES

(71) Applicant: SAFERIDE TECHNOLOGIES LTD., Tel Aviv (IL)

(72) Inventors: Yehiel Stein, Ramat Hasharon (IL); Yossi Vardi, Tel Aviv (IL); Nadav George Costa, Gedera (IL)

(21) Appl. No.: 17/602,781

(22) PCT Filed: Apr. 8, 2020
(86) PCT No.: PCT/IL2020/050432

§ 371 Date: Oct. 11, 2021

Related U.S. Application Data
(60) Provisional application No. 62/832,393, filed on Apr. 11, 2019.
(60) Provisional application No. 62/841,854, filed on May 2, 2019.

(51) Int. Cl. G06F 21/55; G06F 21/56; G06F 21/85; G06K 9/62; G06N 3/04; H04L 12/40

(52) U.S. Cl. CPC G06F 21/552; G06F 18/214; G06F 21/567; G06F 21/85; G06N 3/04; H04L 12/40013; H04L 2012/40215

(57) ABSTRACT

A system for detecting Controller Area Network (CAN) messages anomalies, the system comprising a processing resource configured to: obtain a training set including training CAN messages associated with respective one or more vehicles; and train an anomaly detection model, using the training set, the anomaly detection model comprising one or more CAN message type anomaly detection models for one or more respective CAN message types that appear in the training set, each of the CAN message type anomaly detection models characterizing a functional dependency, if any, between one or more parts of values of payloads and interarrival times of CAN messages of the respective CAN message type, the interarrival times being determined using a timestamps associated with the CAN messages of the respective CAN message type; wherein the anomaly detection model is usable for classifying an unclassified CAN message of a given CAN message type as anomalous or non-anomalous.

### TECHNICAL FIELD

The presently disclosed subject matter relates to a system and method for detection of anomalous messages, and in more specific cases for detection of anomalous CAN messages.

### BACKGROUND

The presently disclosed subject matter, in some embodiments thereof, relates to identifying an abnormal/anomalous event in an operational environment of a vehicle, and, more specifically, but not exclusively, to identifying an abnormal/anomalous event in an operational environment of a vehicle (a) by using an anomaly detection model generated based on machine learning analysis of messages transmitted over communication channels of the vehicle, or (b) by detection of anomalous CAN messages in view of a context based on machine learning analysis of messages transmitted over communication channels of the vehicle

The operation of vehicles such as, for example, cars, trucks, motorcycles, buses, trains, airplanes, drones, naval vessels, and/or the like has long ago become heavily reliant on automated systems utilizing multiple Electronic Control Units (ECU) deployed in the vehicle to control almost every aspect of the operation of the vehicle. This trend is naturally further intensified with the evolution of autonomic vehicles where the human factor, i.e. the human driver, is no longer the prime controller of the vehicle which is rather controlled by the automated and autonomous systems.

These automated and optionally autonomous systems may include a plurality of devices, for example, ECUs, sensors, Input/output (I/O) controllers and/or the like communicating with each other to transfer status and/or control data essential for operating the vehicle. These systems may further exchange data with each other thus creating a comprehensive, complex ecosystem within the vehicle.

To support this data exchange, each vehicle may include multiple wired and/or wireless communication channels, for example, Controller Area Network (CAN) bus, Local Interconnect Network (LIN), FlexRay, Local area Network (LAN), Ethernet, automotive Ethernet, Wireless LAN (WLAN, e.g. Wi-Fi), Media Oriented Systems Transport (MOST), Wireless CAN (WCAN) and/or the like to support the data transfer between the deployed devices. The vehicle communication channels are often segmented due to one or more constraints and/or purposes, for example, a requirement for functional segregation, vehicle physical deployment constraints, a hierarchical communication structure and/or the like.

A CAN bus standard, for example, is a vehicle bus standard used by vehicle manufacturers. The CAN bus standard defines, inter alia, a structure of messages (referred to herein as CAN messages) to be transmitted on a vehicle's CAN bus. Each manufacturer, optionally in cooperation with Original Equipment Manufacturers (OEMs) providing parts for the vehicle, can design a custom CAN bus messaging scheme that is based on the CAN bus standard, so that messages (also referred to as CAN messages) can be exchanges between the various system of the vehicles manufactured thereby.

As noted, the automotive industry evolves and more and more vehicles become connected cars equipped with an Internet connection and/or with a wireless local area network, etc. This provides many clear benefits for both the car manufacturers, and the car owners and users. However, this evolution is not risk free. Such vehicles become increasingly sensitive to cyber-attacks and/or malfunctions, which pose a major threat to the car safety, both to the driver/passengers of the vehicle, and to the vehicles surrounding environment (e.g. other vehicles, pedestrians, infrastructure, etc.). It has been proven that cyber-attacks can be aimed at accessing safety-critical components of vehicles, including for example the vehicles throttle, brakes, and steering systems. Such cyber-attacks can be made by injecting CAN messages to the CAN bus, or by manipulating CAN messages, or in any other manner which results in various systems of the vehicle behaving in an undesirable manner.

Accordingly, it is desirable to have an ability to identify unauthorized access to any of the vehicle's sub-systems in order to prevent cyber-attackers from causing any harm. Such unauthorized access can be identified by detecting anomalous CAN messages flowing through the CAN bus, however, detecting such anomalies is not an easy task, since the syntax and the semantic of the CAN messages is maintained confidential by vehicle manufacturers and their suppliers. An additional factor that makes anomaly detection complicated is that some of the data comprised in the CAN messages is driver dependent and can also change over time as various components of the vehicle degrade. It is to be noted that anomalies in CAN messages can also result from malfunctioning of the vehicle, and thus, having the ability to detect anomalies can enable improved maintenance of the vehicle's systems.

There is thus a need in the art for a new method and system for detection of anomalous CAN messages.

### GENERAL DESCRIPTION

In accordance with a first aspect of the presently disclosed subject matter, there is provided a system for detecting Controller Area Network (CAN) messages anomalies, the system comprising a processing resource configured to: obtain a training set including a plurality of training CAN messages associated with respective one or more vehicles, each training CAN message having properties including (a) a CAN message type, (b) a size, (c) a payload, and (d) a corresponding timestamp; wherein for each CAN message type appearing in the plurality of training CAN messages of the training set, the timestamps of the training CAN messages of the corresponding CAN message type are derived from a non-stationary distribution, wherein the training set is ordered according to an interception order of the CAN messages on the respective vehicles; and train an anomaly detection model, using the training set, the anomaly detection model comprising one or more CAN message type anomaly detection models for one or more respective CAN message types that appear in the training set, each of the CAN message type anomaly detection models characterizing a functional dependency, if any, between one or more parts of values of the payloads and interarrival times of CAN messages of the respective CAN message type, the interarrival times being determined using the timestamps of the CAN messages of the respective CAN message type; wherein the anomaly detection model is usable for classifying an unclassified CAN message of a given CAN message type as anomalous or non-anomalous using the CAN message type anomaly detection model associated with the given CAN message type.

In some cases, each of the CAN message type anomaly detection models is trained to learn the functional dependency by learning dependencies between the one or more parts of values of the payloads of the CAN messages of the respective CAN message type within the training set and the interarrival time of the CAN messages of the respective CAN message type within the training set.

In some cases, the processing resource is configured to learn the dependencies using a gated Recurring Neural Network (gRNN) comprising a plurality of gated units, (a) each gated unit receives (i) the payload of a respective CAN message of the respective CAN message type within the training set, and (ii) a temporal vector comprising one or more values based on the timestamps of at least the respective CAN message, and (b) at least one gate of each node is factored based on the temporal vector.

In some cases, the processing resource is further configured use the gRNN to learn the functional dependencies based on autoencoding.

In some cases, at least one of the values is an interarrival time between the respective CAN message of the respective CAN message type within the training set and the subsequent CAN message of the respective CAN message type within the training set.

In some cases, the gated units are Long short-term memory (LSTM) units.

In some cases, a gating mechanism of the gRNN units is a Gated recurrent unit (GRU) gating mechanism.

In some cases, the processing resource is further configured to: receive an ordered sequence of classification CAN messages of a classification CAN message type, ordered according to a second interception order of the classification CAN messages on a given vehicle, the classification CAN messages including at least one unclassified CAN message unclassified as anomalous or non-anomalous; and classify the unclassified CAN message as anomalous or non-anomalous using the CAN message type anomaly detection model associated with the classification CAN message type, giving rise to a classified CAN message.

In some cases, the classification of the unclassified CAN message is performed by inputting the ordered sequence of classification CAN messages into the CAN message type anomaly detection model associated with the classification CAN message type.

In some cases, the processing resource is further configured to perform an action upon the classified CAN message being classified as anomalous.

In some cases, the action includes one or more of the following: providing an alert to an entity indicative of the classified CAN message being anomalous; or performing a prevention measure for blocking or correcting the classified CAN message wherein the classified CAN message is classified as anomalous before it is transmitted on a CAN bus of a monitored vehicle.

In some cases, the entity is one or more of: a driver of a vehicle associated with the classified CAN message, a mechanic service provider, a cyber analyst, a car manufacturer, an Original Equipment Manufacturer (OEM), or a fleet manager.

In accordance with a second aspect of the presently disclosed subject matter, there is provided a method for detecting Controller Area Network (CAN) messages anomalies, the method comprising: obtaining, by a processing resource, a training set including a plurality of training CAN messages associated with respective one or more vehicles, each training CAN message having properties including (a) a CAN message type, (b) a size, (c) a payload, and (d) a corresponding timestamp; wherein for each CAN message type appearing in the plurality of training CAN messages of the training set, the timestamps of the training CAN messages of the corresponding CAN message type are derived from a non-stationary distribution, wherein the training set is ordered according to an interception order of the CAN messages on the respective vehicles; and training, by the processing resource, an anomaly detection model, using the training set, the anomaly detection model comprising one or more CAN message type anomaly detection models for one or more respective CAN message types that appear in the training set, each of the CAN message type anomaly detection models characterizing a functional dependency, if any, between one or more parts of values of the payloads and interarrival times of CAN messages of the respective CAN message type, the interarrival times being determined using the timestamps of the CAN messages of the respective CAN message type; wherein the anomaly detection model is usable for classifying an unclassified CAN message of a given CAN message type as anomalous or non-anomalous using the CAN message type anomaly detection model associated with the given CAN message type.

In some cases, each of the CAN message type anomaly detection models is trained to learn the functional dependency by learning dependencies between the one or more parts of values of the payloads of the CAN messages of the respective CAN message type within the training set and the interarrival time of the CAN messages of the respective CAN message type within the training set.

In some cases, the CAN message type anomaly detection models learns the dependencies using a gated Recurring Neural Network (gRNN) comprising a plurality of gated units, (a) each gated unit receives (i) the payload of a respective CAN message of the respective CAN message type within the training set, and (ii) a temporal vector comprising one or more values based on the timestamps of at least the respective CAN message, and (b) at least one gate of each node is factored based on the temporal vector.

In some cases, the method further comprises using the gRNN to learn the functional dependencies based on autoencoding.

In some cases, at least one of the values is an interarrival time between the respective CAN message of the respective CAN message type within the training set and the subsequent CAN message of the respective CAN message type within the training set.

In some cases, the gated units are Long short-term memory (LSTM) units.

In some cases, a gating mechanism of the gRNN units is a Gated recurrent unit (GRU) gating mechanism.

In some cases, the method further comprises: receiving, by the processing resource, an ordered sequence of classification CAN messages of a classification CAN message type, ordered according to a second interception order of the classification CAN messages on a given vehicle, the classification CAN messages including at least one unclassified CAN message unclassified as anomalous or non-anomalous; and classifying, by the processing resource, the unclassified CAN message as anomalous or non-anomalous using the CAN message type anomaly detection model associated with the classification CAN message type, giving rise to a classified CAN message.

In some cases, the classification of the unclassified CAN message is performed by inputting the ordered sequence of classification CAN messages into the CAN message type anomaly detection model associated with the classification CAN message type.

In some cases, the method further comprises performing, by the processing resource, an action upon the classified CAN message being classified as anomalous.

In some cases, the action includes one or more of the following: providing an alert to an entity indicative of the classified CAN message being anomalous; or performing a prevention measure for blocking or correcting the classified CAN message wherein the classified CAN message is classified as anomalous before it is transmitted on a CAN bus of a monitored vehicle.

In some cases, the entity is one or more of: a driver of a vehicle associated with the classified CAN message, a mechanic service provider, a cyber analyst, a car manufacturer, an Original Equipment Manufacturer (OEM), or a fleet manager.

In accordance with a third aspect of the presently disclosed subject matter, there is provided a non-transitory computer readable storage medium having computer readable program code embodied therewith, the computer readable program code, executable by a processing resource to perform a method for detecting Controller Area Network (CAN) messages anomalies, the method comprising: obtaining, by the processing resource, a training set including a plurality of training CAN messages associated with respective one or more vehicles, each training CAN message having properties including (a) a CAN message type, (b) a size, (c) a payload, and (d) a corresponding timestamp; wherein for each CAN message type appearing in the plurality of training CAN messages of the training set, the timestamps of the training CAN messages of the corresponding CAN message type are derived from a non-stationary distribution, wherein the training set is ordered according to an interception order of the CAN messages on the respective vehicles; and training, by the processing resource, an anomaly detection model, using the training set, the anomaly detection model comprising one or more CAN message type anomaly detection models for one or more respective CAN message types that appear in the training set, each of the CAN message type anomaly detection models characterizing a functional dependency, if any, between one or more parts of values of the payloads and interarrival times of CAN messages of the respective CAN message type, the interarrival times being determined using the timestamps of the CAN messages of the respective CAN message type; wherein the anomaly detection model is usable for classifying an unclassified CAN message of a given CAN message type as anomalous or non-anomalous using the CAN message type anomaly detection model associated with the given CAN message type.

In accordance with a fourth aspect of the presently disclosed subject matter, there is provided a system for detecting anomalous Controller Area Network (CAN) messages, the system comprising a processing resource configured to: provide an anomaly detector with: (i) at least part of a payload of a given CAN message of a first CAN message type, and (ii) context, being an ordered sequence of at least parts of payloads of CAN messages of a second CAN message type preceding the given CAN message in a sequence of intercepted CAN messages intercepted on a given vehicle; receive, from the anomaly detector, an anomaly indicator indicating if the at least part of the payload of the given CAN message is anomalous in view of the context; and perform an action upon the anomaly indicator indicating that the at least part of the payload of the given CAN message is anomalous in view of the context.

In some case, the first CAN message type and the second CAN message type are an identical given CAN message type.

In some cases, the anomaly detector is generated using an n-gram model trained over a training set, the training set including a plurality of payloads of CAN messages of the identical given CAN message type associated with respective one or more vehicles, wherein the n-gram model models probabilities of appearance of at least part of each of the payloads and respective preceding sequences of payloads preceding the respective at least part of the payload in the training set, and wherein the training set is ordered according to an interception order of the CAN messages comprising the respective payloads on the respective vehicles.

In some cases, the anomaly detector utilizes an indicator table indicating, for each payload of the plurality of payloads, one or more allowed contexts of a plurality of observed contexts observed in the training set, wherein the indicator table is generated based on the n-gram model.

In some cases, a number of unique values of the plurality of payloads is below a threshold.

In some cases, the anomaly detector is generated using an n-gram structures trained over a training set, the training set including a plurality of payloads of CAN messages of the identical given CAN message type associated with respective one or more vehicles, wherein the n-gram structures generate indicators of appearance of at least part of each of the payloads and respective preceding sequences of payloads preceding the respective at least part of the payload in the training set, wherein the training set is ordered according to an interception order of the CAN messages comprising the respective payloads on the respective vehicles and wherein the anomaly detector utilizes an indicator table indicating, for each payload of the plurality of payloads, one or more allowed contexts of a plurality of observed contexts observed in the training set, wherein the indicator table is generated based on the indicators generated by the n-gram structures.

In some cases, a number of unique values of the plurality of payloads is below a threshold.

In some cases, (a) the anomaly detector is generated using word2vec model trained over a training set, the training set including a plurality of payloads of CAN messages of the identical given CAN message type associated with respective one or more vehicles, (b) the word2vec transforms each given payload of the plurality of payloads into a numeric vector expressing a co-occurring payloads of the plurality of payload co-occurring with the at least part of the given payload within the training set, thereby generating a vector space, (c) the word2vec model models relationships between appearance of payloads and respective preceding or succeeding sequences of payloads preceding or succeeding the respective payloads in the training set, and (d) the training set is ordered according to an interception order of the CAN messages comprising the respective payloads on the respective vehicles.

In some cases, the anomaly detector further utilizes t-Distributed Stochastic Neighbor Embedding (tSNE) for reducing dimensions of the vector space to a two-dimensional vector space, if required.

In some cases, the anomaly detector further utilizes Mixture Density Networks (MDN) over the vector space to determine temporal patterns associated with valid regions of transitions within the vector space for a vector representing each payload of the payloads with respect to preceding sequences of payloads preceding or succeeding the respective payload in the training set.

In some cases, a number of unique values of the plurality of payloads is limited.

In some cases, (a) the anomaly detector is generated using parametric t-Distributed Stochastic Neighbor Embedding (tSNE) and Restricted Boltzmann Machine (RBM) model trained over a training set, the training set including a plurality of payloads of CAN messages of the identical given CAN message type associated with respective one or more vehicles, (b) the parametric tSNE and RBM model transforms each given payload of the plurality of payloads into a numeric vector, (c) the parametric tSNE and RBM model embeds the training set, and (d) the training set is ordered according to an interception order of the CAN messages comprising the respective payloads on the respective vehicles.

In some cases, the anomaly detector utilizes a vector space generated by the parametric tSNE and RBM model, wherein the vector space indicates allowed areas within the vector space for a vector representing each payload of the payloads with respect to a preceding or succeeding sequences of payloads preceding or succeeding the respective payload in the training set.

In some cases, the anomaly detector further utilizes Mixture Density Networks (MDN) to learn temporal patterns of the plurality of payloads.

In some cases, the action includes one or more of the following: (a) providing an alert to an entity indicative of the given CAN message being anomalous; (b) performing a prevention measure for blocking or correcting the given CAN message before it is transmitted on a CAN bus of the given vehicle on which the CAN messages is to be transmitted, wherein the sequence is classified before it is transmitted on the CAN bus of the given vehicle.

In some cases, the entity is one or more of: a driver of a vehicle associated with the given CAN message, a mechanic service provider, a cyber analyst, a fleet manager.

In some cases, the entity is a central system configured to receive alerts from a plurality of vehicles, and wherein the central system is configured to provide a user with one or more insights determined based on the anomalies detected within the sequence intercepted on the monitored vehicle, and based on additional anomalies detected within respective additional sequences of additional CAN messages intercepted on respective additional vehicles.

In accordance with a fifth aspect of the presently disclosed subject matter, there is provided a method for detecting anomalous Controller Area Network (CAN) messages, the method comprising: providing, by a processing resource, an anomaly detector with: (i) at least part of a payload of a given CAN message of a first CAN message type, and (ii) context, being an ordered sequence of at least parts of payloads of CAN messages of a second CAN message type preceding the given CAN message in a sequence of intercepted CAN messages intercepted on a given vehicle; receiving, by the processing resource, from the anomaly detector, an anomaly indicator indicating if the at least part of the payload of the given CAN message is anomalous in view of the context; and performing, by the processing resource, an action upon the anomaly indicator indicating that the at least part of the payload of the given CAN message is anomalous in view of the context.

In some cases, the first CAN message type and the second CAN message type are an identical given CAN message type.

In some cases, the anomaly detector is generated using an n-gram model trained over a training set, the training set including a plurality of payloads of CAN messages of the identical given CAN message type associated with respective one or more vehicles, wherein the n-gram model models probabilities of appearance of at least part of each of the payloads and respective preceding sequences of payloads preceding the respective at least part of the payload in the training set, and wherein the training set is ordered according to an interception order of the CAN messages comprising the respective payloads on the respective vehicles.

In some cases, the anomaly detector utilizes an indicator table indicating, for each payload of the plurality of payloads, one or more allowed contexts of a plurality of observed contexts observed in the training set, wherein the indicator table is generated based on the n-gram model.

In some cases, a number of unique values of the plurality of payloads is below a threshold.

In some cases, the anomaly detector is generated using an n-gram structures trained over a training set, the training set including a plurality of payloads of CAN messages of the identical given CAN message type associated with respective one or more vehicles, wherein the n-gram structures generate indicators of appearance of at least part of each of the payloads and respective preceding sequences of payloads preceding the respective at least part of the payload in the training set, wherein the training set is ordered according to an interception order of the CAN messages comprising the respective payloads on the respective vehicles and wherein the anomaly detector utilizes an indicator table indicating, for each payload of the plurality of payloads, one or more allowed contexts of a plurality of observed contexts observed in the training set, wherein the indicator table is generated based on the indicators generated by the n-gram structures.

In some cases, a number of unique values of the plurality of payloads is below a threshold.

In some cases, (a) the anomaly detector is generated using word2vec model trained over a training set, the training set including a plurality of payloads of CAN messages of the identical given CAN message type associated with respective one or more vehicles, (b) the word2vec transforms each given payload of the plurality of payloads into a numeric vector expressing a co-occurring payloads of the plurality of payload co-occurring with the at least part of the given payload within the training set, thereby generating a vector space, (c) the word2vec model models relationships between appearance of payloads and respective preceding or succeeding sequences of payloads preceding or succeeding the respective payloads in the training set, and (d) the training set is ordered according to an interception order of the CAN messages comprising the respective payloads on the respective vehicles.

In some cases, the anomaly detector further utilizes t-Distributed Stochastic Neighbor Embedding (tSNE) for reducing dimensions of the vector space to a two-dimensional vector space, if required.

In some cases, the anomaly detector further utilizes Mixture Density Networks (MDN) over the vector space to determine temporal patterns associated with valid regions of transitions within the vector space for a vector representing each payload of the payloads with respect to preceding sequences of payloads preceding or succeeding the respective payload in the training set.

In some cases, a number of unique values of the plurality of payloads is limited.

In some cases, (a) the anomaly detector is generated using parametric t-Distributed Stochastic Neighbor Embedding (tSNE) and Restricted Boltzmann Machine (RBM) model trained over a training set, the training set including a plurality of payloads of CAN messages of the identical given CAN message type associated with respective one or more vehicles, (b) the parametric tSNE and RBM model transforms each given payload of the plurality of payloads into a numeric vector, (c) the parametric tSNE and RBM model embeds the training set, and (d) the training set is ordered according to an interception order of the CAN messages comprising the respective payloads on the respective vehicles.

In some cases, the anomaly detector utilizes a vector space generated by the parametric tSNE and RBM model, wherein the vector space indicates allowed areas within the vector space for a vector representing each payload of the payloads with respect to a preceding or succeeding sequences of payloads preceding or succeeding the respective payload in the training set.

In some cases, the anomaly detector further utilizes Mixture Density Networks (MDN) to learn temporal patterns of the plurality of payloads.

In some cases, the action includes one or more of the following: (a) providing an alert to an entity indicative of the given CAN message being anomalous; (b) performing a prevention measure for blocking or correcting the given CAN message before it is transmitted on a CAN bus of the given vehicle on which the CAN messages is to be transmitted, wherein the sequence is classified before it is transmitted on the CAN bus of the given vehicle.

In some cases, the entity is one or more of: a driver of a vehicle associated with the given CAN message, a mechanic service provider, a cyber analyst, a fleet manager.

In some cases, the entity is a central system configured to receive alerts from a plurality of vehicles, and wherein the central system is configured to provide a user with one or more insights determined based on the anomalies detected within the sequence intercepted on the monitored vehicle, and based on additional anomalies detected within respective additional sequences of additional CAN messages intercepted on respective additional vehicles.

In accordance with a sixth aspect of the presently disclosed subject matter, there is provided a non-transitory computer readable storage medium having computer readable program code embodied therewith, the computer readable program code, executable by a processing resource to perform a method for detecting anomalous Controller Area Network (CAN) messages, the method comprising: providing, by the processing resource, an anomaly detector with: (i) at least part of a payload of a given CAN message of a first CAN message type, and (ii) context, being an ordered sequence of at least parts of payloads of CAN messages of a second CAN message type preceding the given CAN message in a sequence of intercepted CAN messages intercepted on a given vehicle; receiving, by the processing resource, from the anomaly detector, an anomaly indicator indicating if the at least part of the payload of the given CAN message is anomalous in view of the context; and performing, by the processing resource, an action upon the anomaly indicator indicating that the at least part of the payload of the given CAN message is anomalous in view of the context.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a block diagram schematically illustrating one example of a system for detection of anomalous Controller Area Network (CAN) messages, in accordance with the presently disclosed subject matter;

FIG. 2 is a schematic illustration of an exemplary system for identifying an abnormal event in an operational environment of a vehicle, in accordance with the presently disclosed subject matter;

FIG. 3 is a schematic illustration of an exemplary system for intercepting communication messages exchanged over communication channels of a vehicle, in accordance with the presently disclosed subject matter;

FIG. 4 is a flowchart illustrating one example of a sequence of operations carried out for training an anomaly detection model, in accordance with the presently disclosed subject matter;

FIG. 5 is a flowchart illustrating one example of a sequence of operations carried out for detecting anomalous Controller Area Network (CAN) messages using an anomaly detection model, in accordance with the presently disclosed subject matter;

FIG. 6 is an illustration of an autoencoder usable for reconstruction of a payload part of an input sequence, in accordance with the presently disclosed subject matter; and

FIG. 7 is a flowchart illustrating one example of a sequence of operations carried out for detecting anomalous Controller Area Network (CAN) messages in view of a context, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “obtaining”, “learning”, “training”, “generating”, “receiving”, “classifying”, “performing”, “creating”, “modeling”, “using”, “inputting”, “providing” or the like, include action and/or processes of a computer that manipulate and/or transform data into other data, said data represented as physical quantities, e.g. such as electronic quantities, and/or said data representing the physical objects. The terms “computer”, “processor”, and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a Graphics Processing Unit (GPU), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

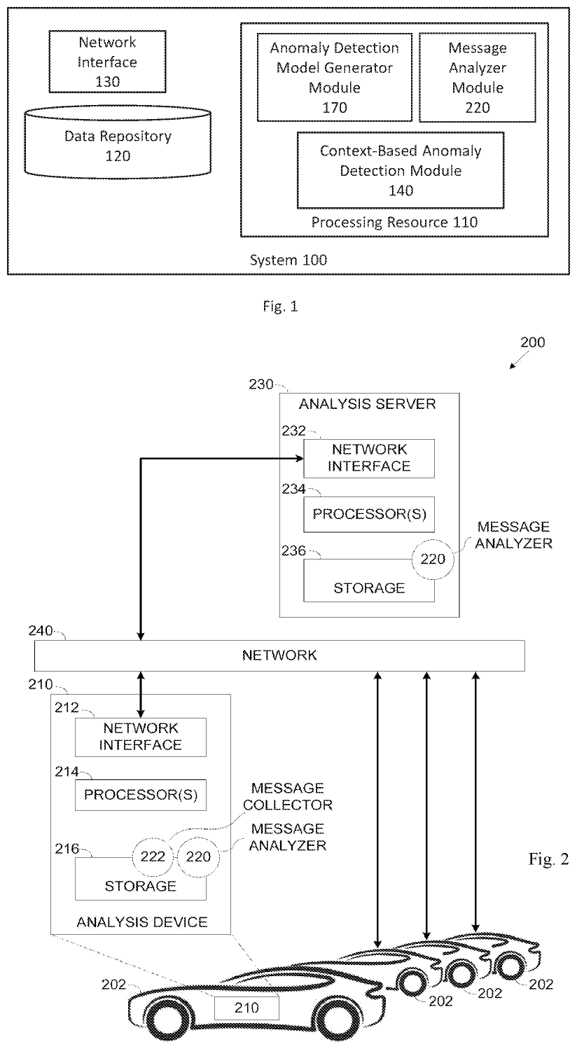

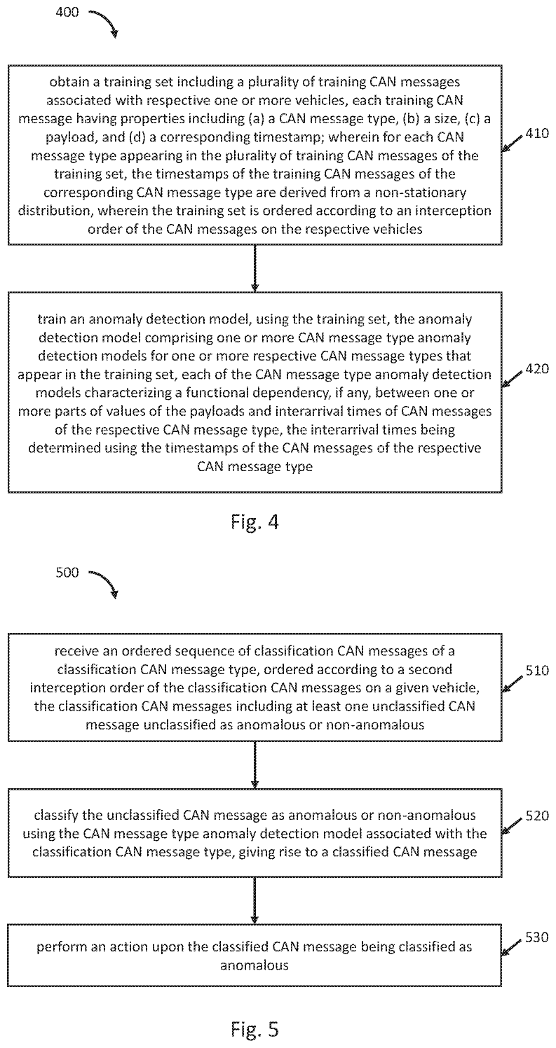

In embodiments of the presently disclosed subject matter, fewer, more and/or different stages than those shown in FIGS. 4, 5 and 7 may be executed. In embodiments of the presently disclosed subject matter one or more stages illustrated in FIGS. 4, 5 and may be executed in a different order and/or one or more groups of stages may be executed simultaneously. FIGS. 1-3 illustrate a general schematic of the system architecture in accordance with an embodiment of the presently disclosed subject matter. Each module in FIGS. 1-3 can be made up of any combination of software, hardware and/or firmware that performs the functions as defined and explained herein. The modules in FIGS. 1-3 may be centralized in one location or dispersed over more than one location. In other embodiments of the presently disclosed subject matter, the system may comprise fewer, more, and/or different modules than those shown in FIGS. 1-3.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Bearing this in mind, attention is drawn to FIG. 1, a block diagram schematically illustrating one example of a system for detection of anomalous Controller Area Network (CAN) messages, in accordance with the presently disclosed subject matter.

According to certain examples of the presently disclosed subject matter, there is provided a system 100 configured to identify anomalies within CAN messages. It is to be noted that whenever reference is made to CAN messages, any type of CAN messages that meet the CAN bus protocol, or any extension thereof is contemplated, including, for example, CAN FD (CAN with Flexible Data-Rate), or any other type of CAN messages. Even more so, the presently disclosed subject matter is applicable to other types of messages, other than CAN messages, including messages that are unrelated to vehicles.

For this purpose, System 100 can comprise, or be otherwise associated with, a data repository 120 (e.g. a database, a storage system, a memory including Read Only Memory—ROM, Random Access Memory—RAM, or any other type of memory, etc.) configured to store data, including, inter alia, one or more training sets usable for generating an anomaly detection model as further detailed herein inter alia with reference to FIG. 4, or an anomaly detector (also referred to herein as: “context-based anomaly detection module”) as further detailed herein inter alia with reference to FIG. 7, while each training set includes a plurality of CAN messages that represent valid operation of a vehicle. In some cases, the data repository 120 can also store the anomaly detection model and/or the anomaly detector generated by the system, e.g. for distributing it to vehicles on which it is to operate and/or for executing it when system receives CAN messages for classification as anomalous or not.

System 100 can comprise a network interface 130 enabling connecting system to various networks such as the Internet and enabling it to send and receive data sent thereto via the networks. As further detailed herein, in some cases, system 100 can be requested to classify messages intercepted on one or more vehicles as anomalous or not.

System 100 further comprises a processing resource 110. Processing resource can include one or more processing units (e.g. central processing units, Graphics Processing Units (GPUs)), microprocessors, microcontrollers (e.g. microcontroller units (MCUs)), or any other computing processing device, which are adapted to independently or cooperatively process data for controlling relevant system 100 resources and for enabling operations related to system 100 resources.

The processing resource 110 comprises a context-based anomaly detection module 140, an anomaly detection model generator module 170, and a message analyzer module 220.

According to some examples of the presently disclosed subject matter, anomaly detection model generator module 170 is configured to generate the anomaly detection model, as further detailed herein, with reference to FIG. 4.

According to some examples of the presently disclosed subject matter, context-based anomaly detection module 140 is configured to indicate if at least part of a payload of a given CAN message is anomalous in view of a context, as further detailed herein, with reference to FIG. 7.

The message analyzer module 220 is configured to analyze a CAN message or a CAN message sequence and classify CAN messages as anomalous or not using the anomaly detection model, as further detailed herein, with reference to FIGS. 2 and 5, and/or to classify the CAN message, or the CAN messages sequences as anomalous or not in view of a context, as further detailed herein, inter alia with reference to FIGS. 2 and 7.

Turning to FIG. 2, there is shown a schematic illustration of an exemplary system for identifying an abnormal event in an operational environment of a vehicle, in accordance with the presently disclosed subject matter.

An exemplary system 200 may include one or more vehicles 202 such as, a car, a truck, a motorcycle, a bus, a train, an airplane, a drone, a boat, and/or the like. According to some embodiments of the presently disclosed subject matter one or more of the vehicles 202 includes a respective analysis device 210 adapted to execute one or more processes for detecting anomalies, as further detailed herein, inter alia with reference to FIG. 4. However, according to some embodiments of the presently disclosed subject matter the processes for detecting anomalies are executed by a remote analysis server 230 (that can optionally be system 100) for one or more vehicles 202. In such cases, the data for analysis can be stored on a removable storage device of the vehicles and provided to the remote analysis server 230 occasionally, by removing the removable storage device from the vehicles 202 and exporting the data to remote analysis server 230 (e.g. by connecting it to the remote analysis server 230 and copying the data). In other cases, the vehicles 202 can be operatively connected to the analysis server 230 via a network 240 comprising one or more wired and/or wireless networks, for example, a Radio Frequency (RF) link, a LAN, a WLAN, a Wide Area Network (WAN), a Municipal Area Network (MAN), a cellular network, the internet and/or the like, which enables the vehicles 202 to send the data to the remote analysis server 230 via the network. The connection can be a real time connection through which CAN messages intercepted on the vehicle's 202 communication channels are immediately sent to the remote analysis server 230. Optionally, in some embodiments, the connection can be a non-real-time connection so that CAN messages intercepted on the vehicle's 202 communication channels are stored on a buffer and sent to the remote analysis server 230 periodically, in cases where one or more vehicles 202 are not continuously connected to the remote analysis server 230 but rather connect to the remote analysis server 230 occasionally, periodically and/or the like. For example, a certain vehicle 202 may connect to the remote analysis server 230 when parked in a certain parking space, for example, at home, at a work place and/or the like. Moreover, a certain vehicle 202 may take advantage of networking capabilities and/or infrastructures provided by the parking space, for example, connectivity to the network 240. In such case, the certain vehicle 202 may connect to the parking space network infrastructure, for example, a wireless router (e.g. Wi-Fi router) serving as a gateway to provide access to the network 240 and through it to the analysis server 230.

The analysis device 210 may include a network interface 212 to provide connectivity for the vehicle 202, a processor(s) 214 for executing one or more processes for detecting anomalies, and storage 216 for storing program code (serving as program store program store) and/or data. The network interface 212 may include one or more wired and/or wireless network interfaces for connecting to the network 240. The processor(s) 214, homogenous or heterogeneous, may include one or more processing nodes arranged for parallel processing, as clusters and/or as one or more multi core processor(s). The storage 216 may include one or more non-transitory memory devices, either persistent non-volatile devices, for example, a hard drive, a solid-state drive (SSD), a magnetic disk, a Flash array and/or the like and/or volatile devices, for example, a Random-Access Memory (RAM) device, a cache memory and/or the like.

The processor(s) 214 may execute one or more software modules, for example, a process, a script, an application, an agent, a utility, a tool and/or the like each comprising a plurality of program instructions stored in a non-transitory medium such as the storage 216 and executed by one or more processors such as the processor(s) 214.

For example, the processor(s) 214 may execute a message analyzer module 220 for executing one or more processes for detecting anomalies, and for acting accordingly.

In case the process/es for detecting anomalies are executed by the remote analysis server 230, the processor(s) 214 may execute a message collector module 222 for collecting intercepted messages exchanged over one or more communication channels of the vehicle 202. The message collector 222 may further transmit the intercepted messages and/or part thereof to the remote analysis server 230 via the network interface 212 connected to the network 240. In some cases, in order to differentiate between the different vehicles 202, the vehicles 202 Vehicle Identification Numbers (VINs) are used.

The remote analysis server 230 may include a network interface 232 such as the network interface 212 or network interface 130 to provide connectivity for the remote analysis server 230, a processor(s) 234 such as the processor(s) 214 or processing resource 110 for executing processes such as the processes for detecting anomalies and storage 236 such as storage 216 or data repository 120 for storing program code (serving as program store program store) and/or data. Similarly to the storage 216 and data repository 120, the storage 236 may include one or more non-transitory memory devices, either persistent non-volatile devices, for example, a hard drive, a Solid State Drive (SSD), a magnetic disk, a Flash array and/or the like and/or volatile devices, for example, a Random-Access Memory (RAM) device, a cache memory and/or the like. The storage 236 may further comprise one or more network storage devices, for example, a storage server, a network accessible storage (NAS), a network drive, and/or the like.

The processor(s) 234 may execute one or more software modules, for example, a process, a script, an application, an agent, a utility, a tool and/or the like. For example, the processor(s) 234 may execute an analyzer module such as the analyzer 220 for executing the processes for detecting anomalies and taking action accordingly.

Optionally, the remote analysis server 230 and/or the analyzer 220 executed by the remote analysis server 230 are provided, partially, or entirely, as one or more cloud computing services, for example, Infrastructure as a Service (IaaS), Platform as a Service (PaaS), Software as a Service (SaaS) and/or the like such as, for example, Amazon Web Service (AWS), Google Cloud, Microsoft Azure, IBM Cloud, and/or the like.

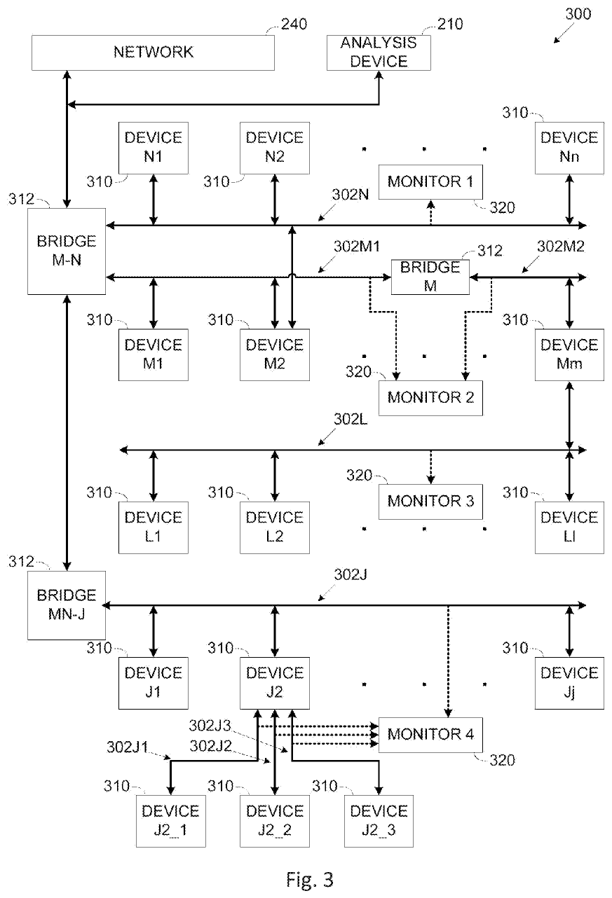

Reference is now made to FIG. 3, which is a schematic illustration of an exemplary system for intercepting communication messages exchanged over communication channels of a vehicle, in accordance with the presently disclosed subject matter.

An exemplary system 300 may be deployed in a vehicle such as the vehicle 202 for intercepting messages exchanged between a plurality of devices 310 deployed in the vehicle 202 for collecting data relating to the operation of the vehicle 202 and/or for controlling one or more functions and or systems of the vehicle 202. The devices 310 may include for example, sensor(s), ECU(s), I/O controller(s), communication controller(s) and/or the like. The topology and deployment of the system 300 is exemplary and should not be construed as limiting since multiple other deployments, topologies and/or layouts may be implemented as known in the art.

The sensors may include one or more sensors, for example, an engine operation sensor, an environmental condition sensor (e.g. temperature sensor, a light sensor, a humidity sensor, etc.), a navigation sensor (e.g. a Global Positioning System (GPS) sensor, an accelerometer, a gyroscope, etc.), an imaging sensor (e.g. a camera, a night vision camera, a thermal camera, etc.) and/or the like. The ECUs may include one or more processing units and/or controllers adapted to operated, control and/or execute one or more functions of the vehicle 202, for example, steering, accelerating, breaking, parking, information collection, safety system control, multimedia system control, door control, window control and/or the like. The I/O controllers may include one or more controllers adapted to connect to one or more of the sensors, the ECUs and/or the like. The I/O controllers may include one or more controllers adapted to operate one or more user interfaces, for example, a pointing device, a keyboard, a display, an audio interface and/or the like. The communication controllers may include one or more controllers adapted to connect to the network 240. Optionally, one or more of the devices 310 may be integrated devices comprising one or more of the sensors, the ECUs, the I/O controllers, the communication controllers and/or the like.

The devices 310 may communicate with each other by sending messages over one or more wired and/or wireless (vehicle) communication channels 302 deployed in the vehicle 202, for example, CAN bus, LIN, FlexRay, LAN, Ethernet, automotive Ethernet, WLAN (e.g. Wi-Fi), WCAN, MOST and/or the like. The topology of the system may vary and may include a plurality of communication channels 302 of various types and various topologies (e.g. bus, point-to-point, multi-drop, etc.) which may be further segmented. By deploying specific types of communication channels 302 and optionally segmenting one or more of them, the topology of the system 300 may be adapted to accommodate one or more needs, constraints and/or objectives of the system 300, for example, apply segregated domain(s) for sensitive devices 310, adapt to deployment physical limitation(s) of the vehicle 202 (e.g. limited space, long distances, etc.), create a hierarchical structure(s) for at least some of the devices 310 and/or the like.

For example, one or more devices 310, for example, a device 310 N1, a device 310 N2 through device 310 Nn may connect to a communication channel 302N, for example, a LIN. In another example, one or more devices 310, for example, a device 310 M1, a device 310 M2 through device Mm may connect to a segmented communication channel 302M, for example, a CAN bus comprising two CAN bus segments 302M1 and 302M2. In another example, one or more devices 310, for example, a device 310 L1, a device 310 L2 through device 310 L1 may connect to a communication channel 302L, for example, a MOST. In another example, one or more devices 310, for example, a device 310 J1, a device 310 J2 through a device 310 Jj may connect to a communication channel 302J, for example, a Wi-Fi network.

The system 300 may further include one or more bridges 312 adapted to connect between communication channels 302 of different types and/or between segments of one or more of the communication channels 302. The bridges 312 may transfer one or more messages from one communication channel 302 to another communication channels 302 in one or both directions to allow propagation of messages between the communication channels 302. Naturally, each bridge 312 includes the appropriate interfaces and/or ports for connecting to the respective communication channels 302 it connects to. For example, a bridge 312 M-N may connect the communication channel 302N and the communication channel 302M. In another example, a bridge 312 MN-J may connect the communication channels 302N and 302M with the communication channels 302J. In another example, a bridge 312 M may connect between the segments 302M1 and 302M2 of the communication channels 302M.

One or more of the devices 310 may also serve as a bridge 312. For example, the device 310 Mm may bridge between the communication channel 302M, specifically the segment 302M2 of the communication channel 302M and the communication channel 302L. In another example, the device 310 J2 may serve as a bridge 312 for connecting a device 310 J2_1, a device 310 J2_2 and/or a device 310 J2_3 to the communication channel 302J where the device 310 J1 connects to the device 310 J2 through a communication channel 302 J1, the device 310 J2 connects to the device 310 J2 through a communication channel 302 J2 and the device 310 J3 connects to the device 310 J2 through a communication channel 302 J3. The communication channels 302 J1, 302 J2 and/or 302 J2 may be of the same type and/or of different types.

The system 300 may further include one or more monitoring devices 320 for monitoring and intercepting communication, specifically messages exchanged between the devices 310 over the communication channels 302. The system 300 may include a central monitor 320 which may connect to a plurality of the communication channels 302. However, the system 300 may include a plurality of monitors 320, for example, a monitor 1 320 which monitors the communication channel 302N, a monitor 2 320 which monitors the communication channel 302M specifically the segments 302M1 and 302M2, a monitor 3 320 which monitors the communication channel 302L, a monitor 4 which monitors the communication channel 302J and/or the like. The monitor 4 may further monitor one or more of the communication channels 302J1, 302J2 and/or 302J3. One or more of the monitors 320 may be integrated in one or more of the devices 310 and/or the bridges 312 such that in addition to its normal operation the integrated device 310 or the integrated bridge 312 may monitor and intercept messages transmitted on the respective communication channel(s) 302 it connects to. According to some embodiments of the present invention, the monitors 320 are receive-only devices which are only capable of intercepting (receiving) the messages transmitted on the communication channel(s) 302 while unable to transmit messages or affect the communication channel(s) 302 in any way. However, in some cases, one or more of the monitors 320 may optionally be configured as active devices that can inject data to the communication channels (or to parts thereof), or manipulate data injected therethrough to the communication channels. This can enable, for example, correcting anomalous messages, preventing anomalous messages from being transmitted over the designated communication channels, etc.

The monitoring device(s) 320 adapted to intercept the messages exchanged over the communication channels 302 may optionally be configured as passive receiver-only device incapable of injecting data to the communication channels 302. Furthermore, the monitoring device(s) 320 may be coupled to the communication channels 302 in an isolated manner thus incapable of inducing, altering, manipulating and/or otherwise affecting the transmission signals of the communication channels 302 in any way. For example, one or more of the monitoring devices 320 may include one or more sensing wires wrapped around one or more insulated wires of one or more of the communication channels 302 such that the sensing wire(s) are incapable of injecting data, messages and/or signals to the communication channel(s) 302. By analyzing the electric load, current and/or voltage of the signals travelling (propagating) through the insulated wires of the communication channel(s) 302 as sensed by the sensing wire(s), the monitoring device(s) 320 may detect messages exchanged over the communication channel(s) 302 and intercept them. In another example, one or more of the monitoring devices 320 may include a wireless receiver-only capable of intercepting wireless messages exchanged between one or more of the devices 210 while incapable of transmitting messages.

In order to be able to correlate the intercepted messages with time and/or space attributes, the monitoring device(s) 320 may assign metadata to one or more of the intercepted messages which may naturally be intercepted at different communication channels 302 at different times. The metadata assigned to the intercepted message(s) may include, for example, a time tag indicating a time of interception of the respective message, a source communication channel 302 where the respective message is intercepted and/or the like. The metadata assigned to the intercepted messages may be used to correlate messages intercepted at various times and/or locations (communication channels 302) to create one, or more, time continuum and/or space continuum meta-events.

The intercepted messages may be transferred (exported) to the analysis server and/or to the analysis device 210 for analysis.

One or more of the devices 310 may be adapted to control a network interface such as the network interface 212 for connecting to a network such as the network 240 to transmit the intercepted messages to the analysis server 230.

The system 300 may further include an analysis device such as the analysis device 210 which may receive the intercepted messages from the monitor(s) 320.

Turning to FIG. 4, there is shown a flowchart illustrating one example of a sequence of operations carried out for training an anomaly detection model, in accordance with the presently disclosed subject matter.

According to the presently disclosed subject matter, the anomaly detection model generator module 170 can be configured to perform an anomaly detection model generation process 400, during which it is configured to generate an anomaly detection model usable for identifying one or more anomalous CAN messages during operation of a vehicle 202. Before turning to describe the anomaly detection model generation process 400, it is to be noted that although reference is made herein to vehicles CAN messages, this is by no means limiting, and the teachings herein can be applied to other types of messages that are transmitted over any of the communications channel(s) 302 of the vehicle 202, and optionally also on other, non-vehicular environments, mutatis mutandis.

The anomaly detection model generated by the anomaly detection model generation process 400 is configured to identify functional dependencies, such as statistical relationships, between payloads values (or parts thereof) and a temporal profile of CAN messages that is determined according to the timestamps of the CAN messages, as detailed herein.

For the purpose of generating the anomaly detection model, the anomaly detection model generator module 170 obtains a training set including a plurality of training CAN messages associated with respective one or more vehicles 202, each training CAN message having properties including (a) a CAN message type (noting that in the CAN bus protocol the message type is also referred to as “arbitration ID”, or as a Message Identifier (MID)), (b) a size, (c) a payload, and (d) a corresponding timestamp (block 410). It is to be noted that for each CAN message type appearing in the plurality of training CAN messages of the training set, the timestamps of the training CAN messages of the corresponding CAN message type are derived from a non-stationary distribution (so that the distribution of interarrival times between CAN messages of the corresponding CAN message type is not constant in time). It is to be further noted that the training set is ordered according to an interception order of the CAN messages on the respective vehicles 202 (so that a first CAN message that was intercepted before a second CAN message will appear before such second CAN message in the training set).

The CAN messages of the training set can be obtained from real-time recordings of CAN messages generated during vehicle rides of vehicles 202 (e.g. using message collectors 222 of vehicles 202 that intercepts CAN messages transmitted over the vehicles 202 CAN bus) and/or from simulations of vehicle rides and/or from any other source, as long as the CAN messages of the training set represent valid operation of the vehicle 202, or at least an assumed valid operation thereof.

It is to be noted that the structure of the CAN messages is defined by known standards. However, each manufacturer defines its own semantic for the messages, without which the relationship between the various types of messages and payloads on the one hand and the respective vehicle functionality—is unknown. Accordingly, it is desirable to train the anomaly detection model using a training set that is based on semantic of CAN messages in the environment on which the anomaly detection model is designed to operate. The training set therefore includes CAN messages that are associated with a common semantic.

In other words, the training set is obtained from vehicles 202, or simulations, that generate, at identical scenarios, messages having the same type, size and payload as messages that are generated by vehicles 202 on which the anomaly detection model is designed to operate (e.g. vehicles of the same make and model as the vehicle 202 on which the ADE is designed to operate). For example, if a vehicle 202 on which the anomaly detection model is designed to operate generates a message of type X, size Y and payload Z when the left turn signal is turned on, the training set is required to include a message of the same type X, same size Y and same payload Z to represent turning on a left turn signal.

Having said that, it is to be noted that the anomaly detection model generator module 170 itself is not required to, and in some implementations does not, have knowledge of the fact that a message of type X, size Y and payload Z represents turning on the left turn signal. More generally, in some cases, the relationship between the CAN message type and a respective functionality of the vehicles 202 (i.e. the semantic of the CAN message) is unknown to the anomaly detection model generator module 170.

Anomaly detection model generator module 170 trains an anomaly detection model, using the training set, the anomaly detection model comprising one or more CAN message type anomaly detection models for one or more respective CAN message types that appear in the training set, each of the CAN message type anomaly detection models characterizing a functional dependencies, such as statistical relationship, if any, between one or more parts of values of the payloads and a temporal profile of CAN messages of the respective CAN message type. The temporal profile can be based on the timestamps (or a transformation thereof) and/or on interarrival times of the CAN messages of the respective CAN message type, that can be determined using the timestamps of the CAN messages of the respective CAN message type in the training set. Accordingly, assuming that the training set includes CAN messages of type X and CAN messages of type Y, the anomaly detection model will include two CAN message type anomaly detection models, one for the CAN messages of type X (noting that such CAN message type anomaly detection model will be trained using a subset of the training set which includes the CAN messages of type X of the training set) and the other for the CAN messages of type Y (noting that such CAN message type anomaly detection model will be trained using another subset of the training set which includes the CAN messages of type Y of the training set).

The anomaly detection model trained at block 420 is usable for classifying an unclassified CAN message of a given CAN message type as anomalous or non-anomalous using the CAN message type anomaly detection model associated with the given CAN message type, as further detailed herein, inter alia with reference to FIG. 5.

Assuming that the training set includes CAN messages of several types, anomaly detection model generator module 170 groups the CAN messages of the training set into groups by their message type, and a CAN message type anomaly detection model is trained for each CAN message type. Each of the CAN message type anomaly detection models is trained to learn the functional dependencies (e.g. statistical relationship) by learning dependencies between (a) the one or more parts of values of the payloads of the CAN messages of the respective CAN message type within the training set and (b) a temporal vector of one or more values that are based on the timestamps. For example, the values can include the timestamps (or a transformation thereof, or any other value associated with the timestamps) and/or interarrival times of the CAN messages of the respective CAN message type within the training set.

In order to model and learn the dependencies, use can be made of a gated Recurring Neural Network (gRNN) in which the hidden layer(s) of the network comprises a plurality of gated units where (a) each gated unit receives (e.g. by being fed as input) (i) the payload (or a part thereof) of a respective CAN message of the respective CAN message type within the training set, and (ii) one or more values (also referred to herein as temporal values) associated with the timestamps of at least the respective CAN message, and (b) at least one gate of each gated unit is factored based on the temporal vector, so that the gates also include independent function/s based on the temporal vector for gaining control of learning based on the temporal profile.

It is to be noted that in some cases, at least one of the values associated with the timestamps of at least the respective CAN message is an interarrival time between the respective CAN message of the respective CAN message type within the training set and the subsequent CAN message of the respective CAN message type within the training set.

The process of learning the dependencies can enable sequences modeling tasks such as classification or autoencoding of the sequences.

When reference is made herein to gRNN, it refers to the well-known Recurring Neural Networks (RNNs) architectures wherein the computational units of the hidden layer have gates, including one or more of: an input gate, an output gate, and a forget/reset gate. One example of a gRNN unit is Long short-term memory (LSTM) which has its known gating mechanism. Another known type of gating mechanism of a gRNN unit is a Gated recurrent unit (GRU) gating mechanism. At its base, the RNN architecture (including the basic gated flavors (LSTM, GRU)) assume no explicit dependency between the time profile (e.g. the inter-arrival time of samples) and the actual signal values of the to-be-modeled timeseries (ts) over time. Under these circumstances, conventionally, the system is gated directly based on input signals values jointly with the recurrent hidden state, with no explicit dependency on the temporal degree of freedom.

According to the presently disclosed subject matter, those known gRNNs are modified so as to take into account, explicitly and inherently to the gating mechanism, a time-related/temporal vector, which may include for example interarrival time between CAN messages of a given CAN message type that is to be modeled.

This strategy of using the temporal profile directly as part of the gating mechanism will result in the ability of controlling the updates of the state/memory cell to allow accurate predictions on payload values over time as being subjected to the temporal profile of the signal, based on the observed temporal patterns. In addition, since in some cases (as for example can happen for asynchronous messages) the temporal profile can present values with no clear bounds, we want to avoid its direct prediction as part of the learning task for detecting anomalies.

Accordingly, when using for example LSTM as the gating unit, each of the well-known input gate, forget gate, and output gate of the LSTM, is further factored by additional functions which depend directly on the temporal vector t, which is formulated based on the timestamp of the respective CAN message, and can include the interarrival time between receipt of the CAN message of a respective CAN message type, and a subsequent CAN message of the respective CAN message type within the training set, subsequent to the CAN message. These functions read:

gₜⁱ=f(W^{input}t)

gₜ^{f}=f(W^{forget}t)

gₜ^{o}=f(W^{out}t)
where t represents the corresponding time vector and includes a preserved cell of constant value 1, so that the last column in all W's represent bias term and i, f, and o stands for input forget and output correspondingly. Also, f may represent an identity function or alternatively the nonlinear sigmoid function.

The updating scheme of the cell state vector c of the gated unit will now be determined according to:

$${c}_{t} = i ⊙ z ⊙ {g}_{t}^{i} + f ⊙ {g}_{t}^{f} ⊙ {c}_{t - 1}$$

where z represents the squashing of the input.

And the hidden state vector (also known as output vector of the LSTM unit) will be determined as follows:

$${h}_{t} = {o}_{t} ⊙ {g}_{t}^{o} ⊙ tanh ( c )$$

By this, the time-related data is used in learning the CAN message type anomaly detection model, and enable the network to learn the payload-time patterns while controlling updating of memory cell and stated directly based on observed temporal patterns.

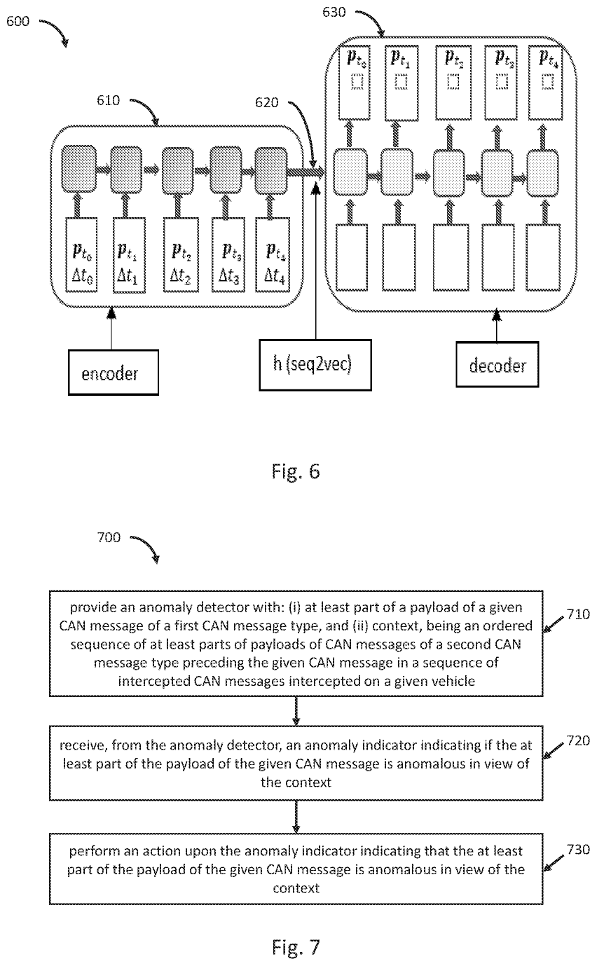

Having the gRNN network, it can be used to create an auto encoder, as illustrated herein in FIG. 6: Autoencoder 600 is comprised from encoder 610 and decoder 630. Encoder 610 and decoder 630 are both built from a network of the gRNN units, as described above.

Autoencoder 600 is used to reconstruct the payload part of the input sequence, as follows: Encoder 610 generates a summarizing state vector h 620, which represents the hidden layer. Summarizing state vector h 620 summarizes the input sequence as it went through the encoder 610. The decoder 630 task is to recreate the input sequence based on summarizing state vector h 620 and on new input which contains zeros instead of payload bits and the same temporal values associated with the timestamps of at least the respective CAN message as in the input.

In some cases, when all-zeroes payloads exist in the data, this input is re-assigned.

The decoder 630 will re-generate the input sequence. It is to be noted that the reconstruction is not exact as intended by autoencoder 600.

As part of the decoder we define an MLP output layer that transforms for each time step the current summarizing state vector h 620 into a payload value. Such autoencoder can be trained by using (e.g.,) Bernoulli cross entropy loss function.

A correctness vector is generated for each of the reconstruction-error vectors based on the outputs of the decoder 630. Each of the correctness vectors is defined as the value of 1 minus the corresponding error vector.

The correctness vectors are used to create a single vector representing at least some of the reconstructed sequences. The single vector can be used as input to a One-Class Support-Vector Machine (OC-SVM) and used to detect anomalies. It is noted that OC-SVM is preferred also due to its capability to model nonlinear decision boundaries.

In some cases, a classification method can be used to classify the input as anomalous or non-anomalous. The classification method is used when the CAN message has a low count of unique payloads. In these cases, each payload is mapped into an index of a label vector of size of unique payloads. Each modeled sequence is labeled by the subsequent payload after being mapped into the corresponding label. The following classification system is used on the sequences and on the corresponding labels. The payload that follow the sequence is transformed into a label. A machine learning classifier is trained using the sequences and the corresponding labels. In run time, given a sequence, the system predicts the label which reflects the expected payload to follow the given sequence. In some cases, a “softmax cross-entropy loss” is used for the classification method. Further, an error vector and correctness vector are defined by comparing the predicted label vector and the real label vector. An OC-SVM is used, to finalize the anomaly detection procedure.

Some exemplary payload-time interactions are now exemplified. In a first example, messages of a first message type which is asynchronous and has only two possible payload values (X or Y) can demonstrate the following behavior: when the payload value is X, the interarrival time between the messages of the first type is smaller than 4 seconds (optionally plus a certain epsilon, which can be set to reflect the noise in CAN traffic). So, when a sequence of messages of the first message type consecutively have the payload values X, the interarrival time between such messages cannot exceed 4 seconds (optionally plus the epsilon). The CAN message type anomaly detection model of CAN messages of the first message type will model this relationship, and will identify anomalous CAN messages that behave differently (e.g. a CAN message of the first CAN message type with a payload value X, that followed an immediately preceding CAN message of the first CAN message type with a payload value X more than 4 seconds thereafter).

In a second example, messages of a second message type which is hybrid where in this case it contains two policies for the values of interarrival time, and has two possible payload values (X or Y) can demonstrate the following behavior: whenever a transition is made between the values (X becomes Y, or Y becomes X), the interarrival time between the messages of the second type is 0.05 seconds (optionally plus a certain epsilon), as oppose to if the payload value remains fix (X remains X or Y remains Y) in which cases the interarrival time between the messages of the second type is 0.25 seconds (optionally plus a certain epsilon)

The CAN message type anomaly detection model of CAN messages of the second message type will model this relationship, and will identify anomalous CAN messages that behave differently (e.g. a CAN message of the second CAN message type with a payload value X, that followed an immediately preceding CAN message of the second CAN message type with a payload value Y wherein the corresponding interarrival time is of 0.25 seconds).

It is to be noted that, with reference to FIG. 4, some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

Before turning to FIG. 5, it is to be noted that some existing solutions for detection of in-vehicle anomalies apply rule-based methods and/or systems to detect the abnormal event(s) by comparing transmission of intercepted messages to predefined rules and identifying incompliance with the rules. Such rule-based implementations may require identifying in advance most if not all possible valid, legitimate and/or normal operation modes or states of the vehicle. Such rule-based methods may further attempt to predict potential abnormal events that are derived from a given known set of threats and define the respective message transmission rules. The rule-based approach may naturally be very limited as it is impossible to predict all operation modes and states as well as abnormal events in advance, based on known threats. The presently disclosed anomaly detection model on the other hand may automatically and constantly evolve through training using the machine leaning algorithms to constantly learn normal vehicle operation scenarios. In addition, the anomaly detection model may be updated using large volumes of realistic training datasets thus significantly improving the accuracy and comprehensiveness of the anomaly detection model. Detecting the abnormal events using the anomaly detection model may therefore be significantly more comprehensive, accurate and/or effective compared to the rule-based implementations.

In addition, adaptation of the rule-based methods and/or systems to new operational modes/states and/or abnormal events may require extensive efforts and/or time to design new rules, to verify proper operation of the adjusted system, to re-deploy the adjusted system in the vehicles and/or the like. In contrast, the presently disclosed anomaly detection model, whether deployed in the vehicle or at an external server, can automatically evolve, optionally in real time, and may therefore significantly reduce such efforts and/or time for adjusting, verifying and/or deploying the system.

Still further, rule-based methods require knowledge of the semantic of the messages and their relationship with the vehicle's components and functionalities. Such information is very sensitive and vehicle manufacturers make vast efforts maintaining it confidential, as having such information may be used for performance of malicious activities on the vehicles. For example, each vehicle manufacturer designs a proprietary CAN matrix which defines the semantic and structure of various types of CAN bus messages that can flow through CAN busses of vehicles manufactured thereby. In some cases, a distinct CAN matrix is generated for each vehicle make and model, even though it is generated by the same vehicle manufacturer (and/or suppliers thereof). The presently disclosed anomaly detection model on the other hand may be generated without having any knowledge and/or understanding of the CAN matrix, e.g. as detailed herein.

Now turning to FIG. 5, there is shown a flowchart illustrating one example of a sequence of operations carried out for detecting anomalous Controller Area Network (CAN) messages using an anomaly detection model, in accordance with the presently disclosed subject matter.

According to the presently disclosed subject matter, the message analyzer module 220 can be configured to perform a message classification process 500. For this purpose, the message analyzer 220 is configured to receive an ordered sequence of CAN messages (referred to herein as classification CAN messages) of a given CAN message type (referred to herein as classification CAN message type), ordered according to an interception order of the classification CAN messages on a given vehicle 202, the classification CAN messages including at least one unclassified CAN message unclassified as anomalous or non-anomalous (block 510).

As described herein above, the message analyzer module 220 may be locally executed by the analysis device 210 which is connected to one or more of the communication channels 302 as described for the system 300. In such case, the message analyzer 220 may receive the receive the ordered sequence of classification CAN messages of the given CAN message type from one or more monitors such as the monitor 320 adapted to monitor the communication channel(s) 302 including the CAN bus and intercept transmitted messages. In case the message analyzer 220 is remotely executed by the analysis server 230 (that, as indicated herein can be system 100), the message analyzer 220 may receive the ordered sequence of classification CAN messages of the given CAN message type from the message collector 222 which may collect the intercepted messages from the monitor(s) 320 and forward them to the analysis server 230 via the network 240.

The message analyzer module 220 classifies the unclassified CAN message as anomalous or non-anomalous using the CAN message type anomaly detection model associated with the classification CAN message type (generated at block 420), giving rise to a classified CAN message, for example as further detailed herein.

An anomalous CAN message may be indicative of an abnormal event in which one or more potentially malicious devices transmitted the anomalous message. Additionally, and/or alternatively, such anomalous message(s) may be indicative of an abnormal event in which one or more legitimate devices and/or systems of the vehicle experience (exhibit) one or more malfunctions and/or failures.

In some cases, the message analyzer module 220 can perform an action upon the classifying the unclassified CAN message as anomalous (block 530).

For example, the action can include initiating an abnormal event alert and/or the like, informing one or more local and/or remote systems/users of the abnormal event and/or the like. optionally, further proactive operations may be taken in response to the abnormal event detection, for example, operate the vehicle 202 to prevent and/or circumvent potentially malicious and/or erroneous control message(s), apply security measures to identify and/or isolate the potentially malicious device(s), deploy emergency and/or maintenance procedures to encounter the malfunction(s) and/or failure(s) and/or the like.

In some cases, the alert can be provided to one or more of the following entities: a driver of a vehicle associated with the classified CAN message, a mechanic service provider (e.g. an automobile repair shop), a cyber analyst, a fleet manager, a car manufacturer, an Original Equipment Manufacturer (OEM), or the like.

In some cases, in addition to, or as an alternative of, providing an alert, the message analyzer 220 can be configured to perform a prevention measure for blocking or correcting the classified CAN message classified as anomalous, before it is transmitted on a CAN bus of a monitored vehicle. It is to be noted that for this purpose, the message analyzer 220 is required to perform the process 500 before the classified CAN message classified as anomalous is transmitted on a CAN bus of a monitored vehicle. This may be possible, for example, when the message analyzer 220 acts as a gateway to the CAN bus.

It is to be noted that, with reference to FIG. 5, some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

Turning to FIG. 7, there is shown a flowchart illustrating one example of a sequence of operations carried out for detecting anomalous Controller Area Network (CAN) messages in view of a context, in accordance with the presently disclosed subject matter.

According to the presently disclosed subject matter, the context-based anomaly detection module 140 can be configured to perform an anomaly detection process 700, during which it is configured to identify one or more anomalous CAN messages in view of a context during operation of a vehicle 202. Before turning to describe the anomaly detection process 700, it is to be noted that although reference is made herein to vehicles CAN messages, this is by no means limiting, and the teachings herein can be applied to other types of messages that are transmitted over any of the communications channel(s) 302 of the vehicle 202, and optionally also on other, non-vehicular environments, mutatis mutandis.

For the purpose of identifying one or more anomalous CAN messages in view of a context, the context-based anomaly detection module 140 is provided with: (i) at least part of a payload of a given CAN message of a first CAN message type, and (ii) context, being an ordered sequence of at least parts of payloads of CAN messages of a second CAN message type preceding the given CAN message in a sequence of intercepted CAN messages intercepted on a given vehicle (block 710).

In order to detect anomalous CAN messages, which are “out of context”, context-based anomaly detection module 140 utilizes context-based modeling for anomaly detection. Context-based modeling utilizes inherent dependencies within sequences of CAN messages, ordered as intercepted from vehicle 202. These inherent dependencies arise from the mechanical and systematic structural constraints of vehicle 202 and from the sequential nature of operations required to operate and drive vehicle 202. A non-limiting example are sequences of CAN message payloads representing steering angles of a steering wheel of vehicle 202: when rotating the steering wheel, sequences of CAN message payloads representing steering angles of the steering wheel are not generated arbitrarily, as the rotation of the steering wheel cannot be changed without limitations arising from the mechanical structural constraints of the steering wheel, for example: after turning the steering wheel left, the steering wheel must pass through the center before turning right. In this example, context-based anomaly detection module 140 can receive at least part of a payload of a given CAN message representing the steering wheel is turned right and a context. The context being that the steering wheel is turned left. Context-based anomaly detection module 140 can indicate that the given CAN message is anomalous in view of the context as the context did not contain an at least part of a payload of a CAN message representing the steering wheel passed through center before turning right.

In some cases, the context is an ordered sequence of at least parts of payloads of CAN messages of a given length. In these cases, the training of context-based anomaly detection module 140, as further detailed below, is based on sequences of CAN messages of the given length within a training set.

It is to be noted that is some cases the first CAN message type and the second CAN message type are an identical given CAN message type. In these cases, the context-based anomaly detection module 140 can be generated by using one or more machine learning methods. These machine learning methods can be associated with language models such as: n-grams, and embedding techniques such as word to vector (word2vec), and can be also associated with visualization based methods such as t-Distributed Stochastic Neighbor Embedding (tSNE) and/or its extension: parametric tSNE or any other machine learning method that can be used for context anomaly detection. At least some of these machine learning models can be optionally combined with a Mixture Density Networks (MDN) model to determine valid temporal patterns associated with valid sequences of CAN messages against which anomalies can be detected, as further detailed below.

The machine learning models are trained using a training set comprising CAN messages. The CAN messages of the training set can be obtained from real-time recordings of CAN messages generated during vehicle rides of vehicles 202 (e.g. using message collectors 222 of vehicles 202 that intercepts CAN messages transmitted over the vehicles 202 CAN bus) and/or from simulations of vehicle rides and/or from any other source, as long as the CAN messages of the training set represent valid operation of the vehicle 202, or at least an assumed valid operation thereof. It is to be noted that the training set is ordered according to an interception order of the CAN messages from the vehicles 202.

It is to be noted that the structure of the CAN messages is defined by known standards. However, each manufacturer defines its own semantic for the messages, and specifically for the payload of the CAN messages, without which identification of valid sequences of payloads of CAN messages of various types representing valid vehicle functionality—is unattainable. Accordingly, it is desirable to train the context-based anomaly detection module 140 using a training set that is based on semantic of CAN messages in the environment on which the context-based anomaly detection module 140 is designed to operate. The training set therefore includes CAN messages that are associated with a common semantic.

In other words, the training set is obtained from vehicles 202, or simulations, that generate, at identical scenarios, messages having the same type, size and payload as messages that are generated by vehicles 202 on which the context-based anomaly detection module 140 is designed to operate (e.g. vehicles of the same make and model as the vehicle 202 on which the context-based anomaly detection module 140 is designed to operate). For example, if a vehicle 202 on which the context-based anomaly detection module 140 is designed to operate generates a sequence of messages of type X, with payloads Y1 and Y2 when the steering wheel is turned left, the training set is required to include a message of the same type X with same payloads Y1 and Y2 to represent turning the steering wheel left.

Having said that, it is to be noted that the context-based anomaly detection module 140 itself is not required to, and in some implementations does not, have knowledge of the fact that a message of type X, payloads Y1 and Y2 represent turning the steering wheel left. More generally, in some cases, the relationship between the sequences of CAN message payloads (or parts thereof) and a respective functionality of the vehicles 202 (i.e. the semantic of the CAN message) is unknown to the context-based anomaly detection module 140.

In some cases, an n-gram model can be utilized to generate the context-based anomaly detection module 140. N-gram model is a Natural Language Processing (NLP) method that can be used to predict the appearance of a specific a word given a context, which is a sequence of words preceding the specific word. In some cases, a number of unique values of a plurality of payloads of CAN messages of the modeled CAN message type in the training set is below a first threshold.

In this case, payloads (or parts thereof) of CAN messages are used as input to the n-gram models in a similar way of using n-gram models to model words of a natural language. The n-gram model can be trained over the training set that includes a plurality of payloads of CAN messages of one or more CAN message types associated with respective one or more vehicles 202. The n-gram model models conditional probabilities of appearance of at least part of each of the payloads and respective contexts, which are sequences of payloads preceding the respective at least part of the payload in the training set. In some cases, the context-based anomaly detection module utilizes an indicator table indicating, for each payload of the plurality of payloads, one or more allowed contexts of a plurality of observed contexts observed in the training set. In some cases, each entry in the indicator table can be a binary indicator, indicating for a given payload, if a given context is allowed. The indicator table can be generated based on the conditional probabilities of appearance of at least part of each of the payloads and respective preceding sequences of payloads preceding the respective at least part of the payload in the training set modeled by the n-gram model, for example: if the conditional probability of a given at least part of a payload to appear after a respective preceding sequences of payloads is above a second threshold the indicator will indicate that the appearance of the given at least part of the payload in the context of the respective preceding sequences of payloads is non-anomalous. In these cases, the context-based anomaly detection module 140, can identify a given payload of a given CAN message (for example: a given CAN message intercepted from vehicle 202) succeeding a given context (for example: a sequence of payload of a sequence of CAN messages intercepted from vehicle 202 preceding the given CAN message) as anomalous, upon the respective indicator within the indicator table associated with the given payload and the given context indicate that the given context is not-allowed for the given payload.

In some cases, an n-gram structures can be utilized to generate the context-based anomaly detection module 140. N-gram structures are used to identify the counts of the n-grams relations (and not their conditional probabilities). In these cases, if a given at least part of a payload is not observed at all in a given context the indication table will indicate the appearance of the given at least part of the payload in the given context as anomalous. In these cases, the context-based anomaly detection module 140, can identify a given payload of a given CAN message (for example: a given CAN message intercepted from vehicle 202) succeeding a given context (for example: a sequence of payload of a sequence of CAN messages intercepted from vehicle 202 preceding the given CAN message) as anomalous, upon the respective indicator within the indicator table associated with the given payload and the given context indicate that the given context is not-allowed for the given payload.

In some cases, a word2vec model can be utilized to generate the context-based anomaly detection module 140. The word2vec model is trained over a training set. The training set can include a plurality of payloads of CAN messages of the modeled CAN message type associated with respective one or more vehicles 202. In these cases, the number of unique values of the plurality of payloads is limited. Word2vec transforms each given payload of the plurality of payloads into a numeric vector expressing co-occurring payloads of the plurality of payload co-occurring with the at least part of the given payload within the training set, thereby generating a vector space. The word2vec model models relationships between appearance of payloads and respective preceding and/or succeeding sequences of payloads preceding and/or succeeding the respective payloads in the training set.

In some cases, the context-based anomaly detection module 140 further utilizes t-Distributed Stochastic Neighbor Embedding (tSNE) for reducing dimensions of the vector space to a two-dimensional vector space, if required.

In these cases, the context-based anomaly detection module 140 can further utilize a Mixture Density Networks (MDN) model over the vector space to determine temporal patterns associated with valid regions of transitions within the vector space for a vector representing each payload of the payloads with respect to preceding or succeeding sequences of payloads preceding or succeeding the respective payload in the training set.

In these cases, the context-based anomaly detection module 140, can identify a given payload of a given CAN message (for example: a given CAN message intercepted from vehicle 202) within a given context (for example: a sequence of payload of a sequence of CAN messages intercepted from vehicle 202 preceding or succeeding the given CAN message) as anomalous, upon the MDN model indicating (based on the training set) that the distance of the vector representing the given payload within the given context is above a likelihood threshold.

A non-limiting example can be parts of payloads of CAN messages representative of a speed of the vehicle 202. As the vehicle 202 has mechanical limitations, the sequence of at least part of the payloads cannot change from values representing a speed of 80 km/h to a speed 200 km/h within a single message of the sequence. For example, payloads co-occurring within a sequence around an example payload representing a speed of 90 km/h are expected to be 88 km/h, 89 km/h, 91 km/h, km/h, etc. In this example context-based anomaly detection module 140 will be generated by using word2vec on the training set and MDN will be utilized to determine temporal patterns associated with valid regions of transitions from the example payload: the word2vec makes sure that payloads representing speeds in the same vicinity are close to each-other in the vector space (thus, vectors far away in the vector space can indicate an anomaly) and the MDN trained on this vector space reflects the quality of the vector space. A payload representing a speed that is out of these valid regions, for example a payload of a CAN message representing speed of 200 km/h will be indicated as anomalous, given that this transition is infeasible for vehicle 202.

In some cases, parametric t-Distributed Stochastic Neighbor Embedding (tSNE) and Restricted Boltzmann Machine (RBM) models can be utilized to generate the context-based anomaly detection module 140. The tSNE and RBM models are trained over a training set. The training set can include a plurality of payloads of CAN messages of the identical given CAN message type associated with respective one or more vehicles. The training results in the embedding of the payloads into a new vector space (i.e. a new embedding space). The parametric tSNE and RBM model embeds each given payload of the plurality of payloads into a numeric vector wherein The RBM model is used as an auxiliary model, to train the tSNE layer by layer. The parametric tSNE and RBM model embeds the training set, regardless of its order. In these cases, the context-based anomaly detection module 140 utilizes a vector space generated by the parametric tSNE and RBM model, wherein the vector space indicates allowed areas within the vector space for a vector representing each payload of the payloads. The context-based anomaly detection module 140 further utilizes Mixture Density Networks (MDN) to learn temporal patterns (i.e. patterns) of the plurality of payloads after the dimension reduction achieved by the tSNE. In these cases, the context-based anomaly detection module 140, can identify a given payload of a given CAN message (for example: a given CAN message intercepted from vehicle 202) within a given context (for example: a sequence of payload of a sequence of CAN messages intercepted from vehicle 202 preceding or succeeding the given CAN message) as anomalous, upon the MDN model indicating (based on the training set) that the distance of the vector representing the given payload within the given context is above a likelihood threshold.

After generating the context-based anomaly detection module 140, anomaly detection process 700 is further configured to receive, from the context-based anomaly detection module 140, an anomaly indicator indicating if the at least part of the payload of the given CAN message is anomalous in view of the context (block 720).

An anomalous at least part of the payload of the given CAN message may be indicative of an abnormal event in which one or more potentially malicious devices transmitted the anomalous at least part of the payload of the given CAN message. Additionally, and/or alternatively, such anomalous given CAN message(s) may be indicative of an abnormal event in which one or more legitimate devices and/or systems of the vehicle experience (exhibit) one or more malfunctions and/or failures.

Anomaly detection process 700 is than configured to perform an action upon the anomaly indicator indicating that the at least part of the payload of the given CAN message is anomalous in view of the context (block 730).

For example, the action can include initiating an abnormal event alert and/or the like, informing one or more local and/or remote systems/users of the abnormal event and/or the like. optionally, further proactive operations may be taken in response to the abnormal event detection, for example, operate the vehicle 202 to prevent and/or circumvent potentially malicious and/or erroneous control message(s), apply security measures to identify and/or isolate the potentially malicious device(s), deploy emergency and/or maintenance procedures to encounter the malfunction(s) and/or failure(s) and/or the like.

In some cases, the alert can be provided to one or more of the following entities: a driver of a vehicle associated with the classified CAN message, a mechanic service provider (e.g. an automobile repair shop), a cyber analyst, a fleet manager, a car manufacturer, an Original Equipment Manufacturer (OEM), or the like.

In some cases, in addition to, or as an alternative of, providing an alert, the message analyzer 220 can be configured to perform a prevention measure for blocking or correcting the classified CAN message classified as anomalous, before it is transmitted on a CAN bus of a monitored vehicle. It is to be noted that for this purpose, the message analyzer 220 is required to perform the anomaly detection process 700 before the classified CAN message classified as anomalous is transmitted on a CAN bus of a monitored vehicle. This may be possible, for example, when the message analyzer acts as a gateway to the CAN bus.

It is to be noted that, with reference to FIG. 7, some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A system for detecting Controller Area Network (CAN) messages anomalies, the system comprising a processing resource configured to:
obtain a training set including a plurality of training CAN messages associated with respective one or more vehicles, each training CAN message having properties including (a) a CAN message type, (b) a size, (c) a payload, and (d) a corresponding timestamp; wherein for each CAN message type appearing in the plurality of training CAN messages of the training set, the timestamps of the training CAN messages of the corresponding CAN message type are derived from a non-stationary distribution, wherein the training set is ordered according to an interception order of the CAN messages on the respective vehicles; and
train an anomaly detection model, using the training set, the anomaly detection model comprising one or more CAN message type anomaly detection models for one or more respective CAN message types that appear in the training set, each of the CAN message type anomaly detection models characterizing a functional dependency, if any, between one or more parts of values of the payloads and interarrival times of CAN messages of the respective CAN message type, the interarrival times being determined using the timestamps of the CAN messages of the respective CAN message type;
wherein the anomaly detection model is usable for classifying an unclassified CAN message of a given CAN message type as anomalous or non-anomalous using the CAN message type anomaly detection model associated with the given CAN message type.

2. The system of claim 1, wherein each of the CAN message type anomaly detection models is trained to learn the functional dependency by learning dependencies between the one or more parts of values of the payloads of the CAN messages of the respective CAN message type within the training set and the interarrival time of the CAN messages of the respective CAN message type within the training set.

3. The system of claim 2, wherein the processing resource is configured to learn the dependencies using a gated Recurring Neural Network (gRNN) comprising a plurality of gated units, (a) each gated unit receives (i) the payload of a respective CAN message of the respective CAN message type within the training set, and (ii) a temporal vector comprising one or more values based on the timestamps of at least the respective CAN message, and (b) at least one gate of each node is factored based on the temporal vector.

4. The system of claim 3, wherein the processing resource is further configured use the gRNN to learn the functional dependencies based on autoencoding.

5. The system of claim 3, wherein at least one of the values is an interarrival time between the respective CAN message of the respective CAN message type within the training set and the subsequent CAN message of the respective CAN message type within the training set.

6-7. (canceled)

8. The system of claim 1, wherein the processing resource is further configured to:
receive an ordered sequence of classification CAN messages of a classification CAN message type, ordered according to a second interception order of the classification CAN messages on a given vehicle, the classification CAN messages including at least one unclassified CAN message unclassified as anomalous or non-anomalous; and
classify the unclassified CAN message as anomalous or non-anomalous using the CAN message type anomaly detection model associated with the classification CAN message type, giving rise to a classified CAN message.

9. The system of claim 8, wherein the classification of the unclassified CAN message is performed by inputting the ordered sequence of classification CAN messages into the CAN message type anomaly detection model associated with the classification CAN message type.

10. The system of claim 9, wherein the processing resource is further configured to perform an action upon the classified CAN message being classified as anomalous.

11. The system of claim 10, wherein the action includes one or more of the following:
(a) providing an alert to an entity indicative of the classified CAN message being anomalous; or
(b) performing a prevention measure for blocking or correcting the classified CAN message wherein the classified CAN message is classified as anomalous before it is transmitted on a CAN bus of a monitored vehicle.

12. The system of claim 11, wherein the entity is one or more of: a driver of a vehicle associated with the classified CAN message, a mechanic service provider, a cyber analyst, a car manufacturer, an Original Equipment Manufacturer (OEM), or a fleet manager.

13. A method for detecting Controller Area Network (CAN) messages anomalies, the method comprising:
obtaining, by a processing resource, a training set including a plurality of training CAN messages associated with respective one or more vehicles, each training CAN message having properties including (a) a CAN message type, (b) a size, (c) a payload, and (d) a corresponding timestamp; wherein for each CAN message type appearing in the plurality of training CAN messages of the training set, the timestamps of the training CAN messages of the corresponding CAN message type are derived from a non-stationary distribution, wherein the training set is ordered according to an interception order of the CAN messages on the respective vehicles; and
training, by the processing resource, an anomaly detection model, using the training set, the anomaly detection model comprising one or more CAN message type anomaly detection models for one or more respective CAN message types that appear in the training set, each of the CAN message type anomaly detection models characterizing a functional dependency, if any, between one or more parts of values of the payloads and interarrival times of CAN messages of the respective CAN message type, the interarrival times being determined using the timestamps of the CAN messages of the respective CAN message type;
wherein the anomaly detection model is usable for classifying an unclassified CAN message of a given CAN message type as anomalous or non-anomalous using the CAN message type anomaly detection model associated with the given CAN message type.

14. The method of claim 13, wherein each of the CAN message type anomaly detection models is trained to learn the functional dependency by learning dependencies between the one or more parts of values of the payloads of the CAN messages of the respective CAN message type within the training set and the interarrival time of the CAN messages of the respective CAN message type within the training set.

15. The method of claim 14, wherein the CAN message type anomaly detection models learns the dependencies using a gated Recurring Neural Network (gRNN) comprising a plurality of gated units, (a) each gated unit receives (i) the payload of a respective CAN message of the respective CAN message type within the training set, and (ii) a temporal vector comprising one or more values based on the timestamps of at least the respective CAN message, and (b) at least one gate of each node is factored based on the temporal vector.

16. The method of claim 15, further comprising using the gRNN to learn the functional dependencies based on autoencoding.

17. The method of claim 15, wherein at least one of the values is an interarrival time between the respective CAN message of the respective CAN message type within the training set and the subsequent CAN message of the respective CAN message type within the training set.

18-19. (canceled)

20. The method of claim 13, further comprising:
receiving, by the processing resource, an ordered sequence of classification CAN messages of a classification CAN message type, ordered according to a second interception order of the classification CAN messages on a given vehicle, the classification CAN messages including at least one unclassified CAN message unclassified as anomalous or non-anomalous; and
classifying, by the processing resource, the unclassified CAN message as anomalous or non-anomalous using the CAN message type anomaly detection model associated with the classification CAN message type, giving rise to a classified CAN message.

21. The method of claim 20, wherein the classification of the unclassified CAN message is performed by inputting the ordered sequence of classification CAN messages into the CAN message type anomaly detection model associated with the classification CAN message type.

22. The method of claim 21, further comprising performing, by the processing resource, an action upon the classified CAN message being classified as anomalous.

23. The method of claim 22, wherein the action includes one or more of the following:
(a) providing an alert to an entity indicative of the classified CAN message being anomalous; or
(b) performing a prevention measure for blocking or correcting the classified CAN message wherein the classified CAN message is classified as anomalous before it is transmitted on a CAN bus of a monitored vehicle.

24. (canceled)

25. A non-transitory computer readable storage medium having computer readable program code embodied therewith, the computer readable program code, executable by a processing resource to perform a method for detecting Controller Area Network (CAN) messages anomalies, the method comprising:
obtaining, by the processing resource, a training set including a plurality of training CAN messages associated with respective one or more vehicles, each training CAN message having properties including (a) a CAN message type, (b) a size, (c) a payload, and (d) a corresponding timestamp; wherein for each CAN message type appearing in the plurality of training CAN messages of the training set, the timestamps of the training CAN messages of the corresponding CAN message type are derived from a non-stationary distribution, wherein the training set is ordered according to an interception order of the CAN messages on the respective vehicles; and
training, by the processing resource, an anomaly detection model, using the training set, the anomaly detection model comprising one or more CAN message type anomaly detection models for one or more respective CAN message types that appear in the training set, each of the CAN message type anomaly detection models characterizing a functional dependency, if any, between one or more parts of values of the payloads and interarrival times of CAN messages of the respective CAN message type, the interarrival times being determined using the timestamps of the CAN messages of the respective CAN message type;
wherein the anomaly detection model is usable for classifying an unclassified CAN message of a given CAN message type as anomalous or non-anomalous using the CAN message type anomaly detection model associated with the given CAN message type.

26-60. (canceled)
